(19) United States
(12) Patent Application Publication
(10) Pub. No.: US 2007/0141373 A1
(43) Pub. Date: Jun. 21, 2007

(54) Segmented copolyesterether adhesive compositions

(76) Inventors: Eugene G. Sommerfeld, Danvers, MA (US); Balasubramaniam Ramalingam, Cary, NC (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/313,167

(22) Filed: Dec. 20, 2005

(51) Int. Cl. B32B 27/36; B32B 27/32; B32B 5/00; C08L 67/00; B32B 37/00

(52) U.S. Cl. 428/480; 428/500; 525/177

(57) ABSTRACT

The instant invention concerns a composition that is useful as an adhesive in laminating applications. The composition comprises 100 parts of a segmented block copolyesterether and 3-45 parts of a metallocene catalyzed polyethylene co alpha-olefin plastomer, wherein the co alpha olefin is C₃-C₁₂. The adhesive heterophase blend is substantially free of external compatibilizers

### FIELD OF THE INVENTION

The instant invention relates to heterophase blends of segmented copolyesterethers and metallocene catalyzed polyethylene co alpha-olefin plastomers that are useful as adhesives/coatings applied to inorganic or organic substrates by various melt application techniques.

### BACKGROUND OF THE INVENTION

Hot melt adhesives utilizing metallocene catalyzed polyolefins have been found to be advantageous over adhesives made from polyolefins derived from traditional Ziegler-Natta catalysts. Ziegler-Natta catalysts are heterogeneous catalysts that have many active sites, these sites have different levels of activity and selectivity. Metallocene catalysts, in contrast, are homogeneous, or “single-site” catalysts and offer superior control of polymer structure and morphology, as well as molecular weight and distribution. The use of metallocene catalysts also allows incorporation of difficult-to-polymerize monomers, eg certain alpha olefins, into the polymer backbone at levels significantly higher than those possible with the older Ziegler-Natta catalyst technology. The incorporation of alpha olefin comonomers at increased concentrations coupled with the tight control of the polymerization process and monomer distribution has yielded new polyolefin plastomers with potentially enhanced compatibility in polyolefin and other polymer blends

Generally plastics or elastomers consisting of heterophase blends of copolyesters or copolyesterethers and polyethylenes require the addition of polyolefin copolymers that contain functional moieties. Examples of such compositions can be found, for example, in U.S. Pat. Nos. 4,073,827, 4,368,295, 4,771,106, 5,618,881, and 6,462,132; Kalfoglou, et al., Polymer, 36 (23), (1995), 4453-4462; Papadopoulou, et al., Polymer, 41 (7), (2000), 2543-2555. These functional olefins are believed to serve the role of heterophase blend compatiblilizers preventing macrophase separation of the components in the plastic/elastomer which if not utilized would yield heterophase blend alloys with severe losses of their bulk mechanical properties. It is also known that hot melt adhesives involving multiphase blends of copolyesters or copolyesterethers and minor concentrations (<45 wt %) of polyethylene polymers also require the use of external compatibilizer additives to prevent phase separation of the components. These functionalized compatibilizers can cause undesired alterations of the intended adhesive properties (eg. viscosity) when the adhesive is exposed to elevated temperatures for extended periods of time using commercial adhesive application techniques. Unlike the controlled temperature and short time at temperature generally utilized in the production blending and final product extrusion of plastic/elastomer blend products, adhesive applications are less continuous with greater time and time variations at application temperature. In particular, external functionalized compatibilizers can crosslink the polyester segment (resulting in melt viscosity increases) or cause loss of viscosity due to catalyzed saponification or deesterification. This results in unacceptable processability yielding unacceptable adhesive application and/or performance. In addition, non-olefin containing semicrystalline flexible copolyester or copolyesterether adhesives of the prior art tend to rapidly lose adhesion properties over time, particularly when exposed to high temperature and humidity.

Also known in the art are blends of a copolyester or copolyesterether resin and a functionalized polyolefin resin. While exhibiting much better compatibility versus a second component consisting solely of non-functionalized olefins, the functional groups can cause problems similar to those discussed above for heterophase compositions utilizing these functionalized polyolefin as compatibilizers. Compositions using functionalized polyolefins as the sole component in the discrete phase of the blend include those of U.S. Pat. No. 4,720,524.

One approach to providing a composition having improved initial and retained aged adhesion is found in U.S. Pat. No. 6,774,183 which discloses a polyester compound having low polarity block segments in the polyester backbone. The low polarity segments in these compounds can be a polymeric or oligomeric olefin or siloxane.

There is a continued need in the art for polyester or polyesterether polyolefin, and in particular an ethylene containing polyolefin, heterophase blend alloy hot melt adhesives which can avoid the undesirable properties (eg. elevated temperature viscosity stability) of the multiphase adhesives utilizing functionalized compatibilizers taught by the art. There is a further need in the art for such compositions having improved initial and retained aged adhesion particularly, for certain compositions, at sustained exposure to extreme humidity and elevated temperatures.

### SUMMARY OF THE INVENTION

The instant invention concerns a composition that is useful in laminating applications. The composition comprises 100 parts of a segmented copolyesterether and 3 to 45 parts of one or more metallocene catalyzed polyethylene co alpha-olefin plastomer, wherein the alpha olefin is C₃-C₁₂. The composition is substantially free of external compatibilizers. In some embodiments, the invention concerns a composition comprising:
(a) about 100 parts by weight of a segmented copolyesterether derived from:
   one or more C₂-C₁₂ aliphatic or C₅-C₁₂ cycloaliphatic glycol(s);
   α,ω-hydroxy terminated polyalkyleneoxide(s) having a number average molecular weight of from about 250 to about 6000 as determined by calculation using the hydroxyl number titration (2×56100/OH#); and
   one or more of C₈-C₃₆ aromatic dibasic acids, cycloaliphatic dibasic acids, C₆-C₁₂ linear aliphatic dibasic acids and C₁-C₄ dialkylesters thereof; and
(b) about 3 to about 45 parts by weight of one or more metallocene catalyzed polyethylene-co-(C₃-C₁₂) alpha-olefin plastomers having a density of from about 0.85 to about 0.91 g/cm³, said plastomer being substantially free of functional groups; and

the heterophase blend composition being substantially free of an external compatibilizer such as a functionalized polyolefin multiphase blend compatibilizer.

In some embodiments, the preferred weight ratio of (a) to (b) is 100/5 to 100/35. In yet other embodiments, a more preferred weight ratio of (a) to (b) is 100/10 to 100/30.

In certain embodiments of the invention, the compositions are used as adhesives applied in various forms and melted to form the substrate bond.

### DETAILED DESCRIPTION OF ILLUSTRATIVE EMBODIMENTS

The present invention is directed to a segmented copolyesterether metallocene catalyzed polyethylene-co-alpha olefin heterophase adhesive blend with excellent extended elevated temperature application viscosity stability. The blend compositions are tough and flexible even at low temperatures and possess improved initial and retained aged substrate adhesion. Some select compositions, while having excellent low temperature toughness and flexibility, possess very good hydrolytic stability (saponification resistance) and retained substrate adhesion even after prolonged exposure to excessive humidity and elevated temperature. In some embodiments the adhesive is a hot melt adhesive. In certain preferred embodiments, the adhesive is a laminating adhesive. In some cases, the adhesive can be applied or preapplied to inorganic or organic substrates in the form of a dispersion, paste, web or powder followed by post heating to volatize carrier liquids, if any, melt, coalesce and fuse the adhesive blend to an adherend. Suitable substrates include inorganic and organic film, fabric, fiber, and the like.

In some embodiments, the invention concerns a heterophase blend composition comprising:
(a) about 100 parts by weight of a segmented copolyesterether derived from:
   one or more C₂-C₁₂ aliphatic and/or C₅-C₁₂ cycloaliphatic glycol(s);
   α,ω-hydroxy terminated polyalkyleneoxide(s) having a number average molecular weight of from about 250 to about 6000; and
   one or more of C₈-C₃₆ aromatic dibasic acids, cycloaliphatic dibasic acids, C₆-C₁₂ linear aliphatic dibasic acids and C₁-C₄ dialkylesters thereof; and
(b) about 3 to about 45 parts by weight of one or more metallocene catalyzed polyethylene co (C₃-C₁₂ )alpha-olefin plastomer having a density of from about 0.85 to about 0.91 g/cm³, said plastomer being essentially free of reactive functional groups; and

the heterophase blend composition of (a+b) being essentially free of additional compatibilizers and more particularly external reactive funtionalized polyolefin blend compatibilizers.

In certain embodiments, the α,ω-hydroxy terminated polyalkyleneoxide(s) has a number average molecular weight of from about 650 to about 6000. In other embodiments, component a) comprises:
one or more of C₂-C₁₂ aliphatic and C₅-C₁₂ cycloaliphatic glycol(s);
α,ω-hydroxy terminated polyalkyleneoxide(s) having a number average molecular weight of from about 650 to about 6000; and
one or more of C₈-C₃₆ aromatic and cycloaliphatic dibasic acid(s) or their C₁-C₄ dialkylesters.

The C₂-C₁₂ aliphatic and/or C₅-C₁₂ cycloaliphatic glycol(s) can comprise one or more of 1,4-butanediol (also known as 1,4-tetramethylene glycol), 1,6-hexanediol and 1,4-cyclohexanedimethanol. In certain embodiments, the C₂-C₁₂ aliphatic and/or C₅-C₁₂ cycloaliphatic glycol(s) comprises 1,4-butanediol. In yet other embodiments, the C₂-C₁₂ aliphatic and/or C₅-C₁₂ cycloaliphatic glycol comprises cyclohexanedimethanol.

In some embodiments of the invention, the α,ω-hydroxy terminated polyalkyleneoxide is a compound where the alkyl segment is from C₂ to C₈. One such compound is polytetramethyleneoxide glycol. Some polytetramethyleneoxide glycols have a number average molecular weight (Mn) of from about 650 to about 2000.

In some embodiments, aromatic and/or cycloaliphatic dibasic acids or esters are preferred. Suitable C₈-C₃₆ aromatic and/or cycloaliphatic dibasic acids, or their C₁-C₄ dialkylesters include 1,4-cyclohexanedicarboxylic acid (CHDA) and/or terephthalic acid. One preferred C₁-C₄ dialkylester is a dimethylester of one of the aforementioned dibasic acids.

In some aspects, the invention concerns a composition as described herein where the C₂-C₁₂ aliphatic and/or C₅-C₁₂ cycloaliphatic glycol comprises butanediol and/or 1,6-hexanediol and/or cyclohexanedimethanol, the α,ω-hydroxy terminated polyalkyleneoxide is a polytetramethylene glycol, and the C₈-C₃₆ aromatic or cycloaliphatic dibasic acid or their C₁-C₄ dialkylesters is 1,4-cyclohexanedicarboxylic acid, terephthalic acid or isophthalic acid.

In some embodiments, the molecular weight (Mw, weight average) of the segmented copolyesterether is between about 20,000 and 110,000, in some embodiments, between about 30,000 and about 85,000, and in certain embodiments. between about 30,000 and about 75,000. The molecular weight as determined by gel permeation chromatography (GPC) using a polystyrene standard.

In some embodiments, slight branching in the segmented polyesterether elastomer can be utilized. In such compositions, a minor amount of trifunctional glycol (eg trimethylolpropane) or acid (eg trimellitic acid or anhydride) can be used in the composition. The amount of this branching agent is in the range of about 0.1 to about 2 mole % based on the total bound glycols and/or acids.

In some preferred embodiments, the compositions of the instant invention are adhesives. In some embodiments the adhesive is applied in hot melt form (eg. via extruder) to a given substrate and then fused immediately to the surface of the same or an alternate substrate to form an adhesive composite. Alternatively, the hot melt adhesive coated substrate can be cooled, stored and later heat fused to another or same substrate to form the adhesive composite (preapplied adhesive-post heat seal). In some embodiments, the adhesives can be utilized employing various other application techniques. These techniques can include, but not be limited to, application of the adhesive composition in a dispersion, paste, web or powder form onto the substrate surface followed by application of heat to fuse (and in some cases to drive off carrier fluids as well) the adhesive to the substrate surface followed by immediate or delayed (preapplied adhesive) bonding to the surface of the same or alternate substrate. One skilled in the art can readily determine the amount of heat, time and pressure needed for a particular hot melt adhesive application or technique.

In another aspect, the invention concerns an article comprising a substrate and a composition of the instant invention. In some embodiments, the substrate is a fabric or film. In one preferred embodiment, the film is polyethyleneterephthalate.

The invention also concerns a method of making an article comprising applying the composition of the instant invention to a substrate. In some embodiments, the articles comprises two or more layers of the same or different substrates which are bound together by a composition of the instant invention.

Segmented polyesterethers can be made by any conventional method. Preferably, the copolyesterethers are prepared by standard polycondensation processes utilizing difunctional alcohols, α,ω-hydroxy terminated polyalkyleneoxides, and dicarboxylic acids or their dialkylesters. In some embodiments, optionally up to about 2 mole % of polyfunctional branching agents can be used based on the mols total bound glycols and/or acids. In the most prevalent embodiments, the synthesis occurs in two stages, with the first stage being a direct esterification or transesterification (alcohololysis) stage and the second stage being a polyesterification stage. Selective esterification or transesterification and second stage polyesterification catalysts are added at appropriate stages. See. e.g. V. V. Korshak and S. V. Vinogradova, Polyesters, Chapter III, pp. 72-150, Pergamon Press, New York, N.Y., (1965). In some preferred embodiments all reagents are present during first stage. In certain embodiments, the α,ω-hydroxy terminated polyalkyleneoxide can be added at the second stage.

Suitable glycols useful in the practice of the present invention include alkyl diols from C₂ to C₁₂, such as ethylene glycol, diethylene glycol, butanediol, propanediol, hexanediol, neopentyl glycol and the like; and C₅ to C₁₂ cycloaliphatic diols, such as cyclohexanedimethanol and the like. Particularly preferred glycols include butanediol, 1,6-hexanediol and cyclohexanedimethanol.

The invention also utilizes α,ω-hydroxy terminated polyalkyleneoxides. Suitable compounds include those with C₂ to C₈ alkyl groups. One particularly preferred compound is polytetramethyleneoxide glycol. In some embodiments, this compound has a number average molecular weight (Mn) of about 250 to about 6000. In other embodiments. Mn is about 650 to about 3000. In yet other embodiments, Mn is about 650 to about 2000.

Some examples of difunctional carboxylic acids useful in the practice of the present invention include: cycloaliphatic diacids, such as cyclohexane dicarboxylic acid, C₃₆ dicarboxylic dimer fatty acids and the like; and aromatic diacids, such as terephthalic acid, isophthalic acid, naphthalene dicarboxylic acid and the like; and linear aliphatic dibasic acids such as adipic acid, azelaic acid, sebacic acid, dodecandioic acid and the like and the lower (C₁ to C₆) alkyl esters of said dicarboxylic acids. Particularly preferred difunctional carboxylic acids are terephthalic acid, cyclohexanedicarboxylic acid and isophthalic acid.

In the instant compositions, it is preferred that the copolyester segments of the compositions are crystalline in nature (with a Mp>40 deg C.). In some of the preferred compositions one of the criteria for the selection of the monomeric glycols and diacids used in these segments is whether the polyester segment would have good hydrolytic stability. Thus, in some embodiments, ethylene glycol and linear aliphatic diacids or their analogous alkylesters are avoided but C₄ to C₁₂ diols (such as butanediol, neopentyl glycol, hexanediol, cyclohexane dimethanol and the like) and terephthalic, isophthalic, orthophthalic (anhydride) acids or their alkylesters as well as the isomers of cyclohexanedicarboxylate (or its alkylesters) are preferred.

Polyethyleneterephthalate (PET) laminate composites utilizing the most preferred heterogeneous blend compositions of this invention are expected to retain much of the initial adhesive strength and substrate adhesion even after being exposed to 95% relative humidity (RH) at 50° C. for an extended period of time. Ethylene glycol based crystalline flexible copolyesters containing significant amounts of linear aliphatic acid components eventually hydrolyze under these test conditions over time to yield aged laminates with reduced adhesive cohesive strength as well as significantly reduced interfacial substrate adhesion. In certain embodiments, the preferred polyalkyleneoxide glycol of the copolyesterether contains an alkylene segment greater than or equal to C₄ and preferably has a Mn of about 650 to about 2000. One preferred embodiment the copolyesterether uses polytetramethyleneoxide glycol with a Mn of about 1000 to 2000.

Some preferred metallocene catalyzed polyethylene co alpha-olefin plastomers (also commercially referred to as “elastomer”) have a density of about 0.860 to about 0.91 g/cc and a DSC melting point range of 45° to 130° C. In certain embodiments, this component has a melt index of about 2 dg/min to about 100 dg/min (conditions: Melt Index. 190° C./2.16 kg, dg/min as described in ASTM D-1238). Certain metallocene catalyzed polyethylene co alpha-olefins are ultra low density plastomers having a density of 0.865 to 0.889 g/cc and a DSC melting point range of 45° C. to 85° C.

As used herein, a plastomer is defined as a copolymer of ethylene and one or more alkenes. Plastomers useful in the instant invention are typically copolymers of ethylene and alpha olefins having 3 to 10 carbon atoms such as propylene, 1-butene, 1-hexene, and 1-octene. Such plastomers are commercially available from DuPont/Dow Elastomers, under the trademark ENGAGE®, Dow Plastics under the trademark Affinity® and from ExxonMobil Chemicals under the trademarks EXACT® and Vistamaxx®. In some preferred embodiments, suitable polyethylene co alpha-olefins include those where the co alpha-olefin is C₃ to C₁₂. Some preferred compositions use C₃, C₄, C₆ or C₈ co alpha-olefins.

In some embodiments, the metallocene catalyzed polyethylene co alpha-olefin plastomers are made by a process involving reaction of ethylene and at least one C₃-C₁₂ alpha-olefin polymerized using single-site metallocene catalyst.

The segmented polyesterether(s) and the metallocene catalyzed polyethylene co alpha-olefin plastomer(s) or elastomer components (plus minor blend components such as antioxidants, light stabilizers, tackifiers, plasticizers, fillers, pigments, adhesion promoters, waxes, flame retardants, viscosity modifiers/rheology control agents, foaming agents, etc) can be melt blended or mixed by standard means well known to those skilled in the art. These techniques include use of a Buss Kneader Extruder, twin screw extruder, and Braebender or Haake Mixing Chamber (roller blades).

The metallocene catalyzed polyethylene co alpha-olefin plastomers of the instant invention are substantially free of reactive functional groups which would heat react with polyester components or segments. Heat reactive functional groups include glycidyl, carboxylic acid or salts thereof, anhydride, hydroxyl, etc or (meth)acrylate or vinyl ester groups. By substantially free of functional groups it is meant that less than 1.0% of the monomer units of the plastomer contain such a functional group, preferably less than 0.1% in some embodiments, and more preferably no such functional groups are present.

In preferred embodiments, the blend compositions of the present invention do not contain or require external compatibilizers and more particularly heat reactive functionalized compatibilizers (also referred to as external reactive functionalized polyolefin blend compatibilizers). An external compatibilizer is a composition that is added to an adhesive blend of two or more incompatible components to reduce phase separation and discontinuous phase size within the adhesive mixture. With the correct compatibilizer selection and concentration the resultant heterogeneous or multiphase blends have greater phase compatibility as well as adhesion at their interfaces and thus demonstrate significantly improved mechanical and physical properties. When one utilizes external functionalized reactive compatibilizers they are added along with the other components of these blends using compounding extruders with short residence times and at the minimum temperatures to produce the desired heterophase product. However, when these multiphase blends are used commercially as hot melt adhesives they must have retained viscosity stability at much longer residence times as well as higher temperatures in the equipment used in the adhesive application process. It was found that with compositions of the instant invention, external reactive functionalized compatibilizers will either crosslink the copolyester segment in the polyesterether of the blend or at times cause loss of the adhesive blend viscosity due to catalytic saponification of the copolyester segment. This results in unacceptable adhesive processability and application stability along with resultant unacceptable applied adhesive blend properties. As such, it is preferred that the instant invention be performed substantially free of external reactive funtionalized compatibilizers as used in the prior art.

As used herein, “substantially free of external compatibilizer”, means less than 2.5% by weight of the adhesive is such a compatibilizer, preferably less than 1% of the adhesive, more preferably less than 0.5% by weight, and even more preferably no compatibilizer is present. The weights are based on the total weight of the adhesive composition.

Antioxidants may be used in the compositions of the instant invention. Any antioxidants that do not interfere with the desired adhesive properties can be used. Suitable antioxidants include Cyanox® XS4 (Phenolic/Phosphite blend from Cytec Industries) and Irganox® 1010 (from Ciba Specialty Chemicals) and the like.

Light stabilizers may also be used in the instant compositions. Numerous such compounds are known to those skilled in the art and any of these compounds may be used so long as they do not produce undesirable properties. Suitable light stabilizers include Cyasorb® UV 5411 or LV-100 (benzotriazole chemistry) and Cyasorb® UV 1164 (triazine chemistry) from Cytec Industries and Tinuvin® 234 (benzotriazole chemistry) and Tinuvin® 1577 (triazine chemistry) from Ciba Specialty Chemicals.

One advantageous property of the compositions of this invention is that as laminating adhesives they possess improved initial adhesion and retain much of their interfacial substrate adhesion after full crystallization and, in some of the most preferred blend compositions, retain their adhesion even after prolonged exposure to 95% relative humidity (RH) at 50° C. (humidity chamber). Unmodified (free of metallocene catalyzed polyethylene-co-alpha olefin free) semicrystalline copolyesters as well copolyesterether elastomers, applied as an adhesive to polymeric substrates or common metal surfaces, yield decent green peel strengths (within the first 6 hrs of application), but after full crystallization, upon aging (3-4 days after application), the peel values invariably fall 50% or greater of the initial green values. While not wanting to be bound by theory, this property is believed to be due to shrinkage of the applied adhesive as it transitions in time from the amorphous state to the crystalline state resulting in increasing density and decreasing volume. The short-range van der waals forces, initially established by the hot melt applied amorphous adhesive at the adhesive/substrate interface, are believed to be partially destroyed in time by shrinkage along the adhesive/substrate surface breaking a large portion of the initial interfacial adhesion forces. In addition, another consequence of adhesive crystallization, resulting from internal lamella formation, is the volume decrease of the amorphous regions in the bulk adhesive material itself. The amorphous regions within a semicrystalline adhesive are believed to be the primary source of interfacial adhesion forces at a substrate's surface with crystalline and spherulitic regions, for the most part, non-contributing. The blending of 5-45% low density metallocene catalyzed polyethylene co α-olefin (C₃-C₁₂), without the use of external compatibilizers and more particularly reactive functionalized polyolefin compatibilizers, with 100 parts preferred segmented copolyesterether elastomers produced strong green adhesive/substrate interfacial bonds and with similar to even higher bond values after aging seven days. These unique non-functional low density polyolefin plastomer blend components employed in this invention appear to be internally compatibilized and stabilized by the polytetramethyleneoxide ether block segment (650 to 2000 Mw in some embodiments) of the segmented block copolyesterether elastomer. Thus, the resultant metallocene catalyzed polyolefin (“m-polyolefin”) plastomer dispersed discontinuous small phase size, increased continuous/discontinuous interphase formation and good resultant interfacial adhesion at the m-polyolefin plastomer(discontinuous)/segmented block copolyesterether elastomer (continuous) phase boundaries, yielded retained adhesive toughness and cohesive strength in the bulk along with tenacious retained aged adhesion to various substrates. Retained aged adhesion of the most preferred blend compositions is maintained in laminate constructions even after prolonged exposure to elevated humidity and temperatures.

One advantage of the instant invention is that external compatibilizers, and more particularly, reactive functionalized compatibilizers, are not required to prevent macrophase separation of the heterophase blend components and thus these segmented block copolyesterether elastomer—m-polyolefin plastomer based multiphase blend compositions are extremely stable through even abusive and extreme adhesive hot melt processing conditions and applications. Semicrystalline copolyesters (substantially devoid of polyalkyleneoxide block segments) required the use of reactive functionalized olefin compatibilizers when blended with the m-polyolefin copolymers of this invention to prevent gross macrophase separation. Retained aged adhesion was obtained but the adhesive bulk cohesive strength was somewhat lacking due to deficient interfacial adhesion at the phase boundaries even with the use of functionalized compatibilizers. Also, hot melt applications with extended thermal process exposure resulted in viscosity increases up to and including gelation or presented other stability problems depending on the reactive funtionalized polyolefin compatibilizer used. The use of copolyester/functionalized polyolefin copolymer compatibilizer/m-polyolefin plastomer blends as hot melt adhesives are thus undesirable on a commercial basis for various hot melt processing methods and applications.

When the adhesives of the instant invention were applied in thin films (3-5 mils), they appeared transparent to partially translucent. Upon the transmission of visible light the adhesive layer appeared pinkish upon light refraction indicating a dispersed phase size of the m-polyethylene co α-olefin of −0.6 μm. There was no streakiness or macrophase separation and it was observed that these new metallocene catalyzed low-density non-functional polyolefin plastomers/elastomers have much greater compatibility characteristics than the older Ziegler Natta catalyzed linear low density polyethylene (LLDPE). low density polyethylene (LDPE), high density polyethylene (HDPE), polypropylene (PP). The metallocene catalyzed polyethylene-co-(C₃-C₈) alpha olefin plastomers/elastomers, however, appear to be stabilized as the discontinuous phase (partially compatibilized) in these blends by the polyether block segments (eg. polytetramethyleneoxide having a Mn of about 1000 to 2000) that are believed to be acting as an internal polymeric m-polyolefin plastomer surfactant resident in the segmented copolyesterether continuous phase. These plastomers, on the other hand, were found not to be compatible with or compatibilized by copolyesters not containing a polyalkyeneoxide block segments. The adhesive layer in these latter heterophase adhesive blend compositions was opaque, striated and macrophase separated with poor mechanical properties eg. low elongation and tensile strength (poor continuous/discontinuous phase interfacial adhesion) and as such would not or could not yield commercially acceptable adhesives.

Another benefit of the blend compositions of this invention, when such compositions are used in hot melt preapplied film adhesive applications, is improved block resistance (adhesive to uncoated side of film) within the wound-up rollstock. Additionally, in the manufacture of these blend compositions, produced in a Buss Kneader Extruder followed by underwater strand slicing and fluidized bed drying, improved pellet formation and block resistance upon packing (in the collecting container) are observed. The improved block resistance is thought to be due to the m-polyolefin plastomer dispersed phase in the adhesive blend producing lower energy improved release surfaces.

The invention also relates to articles comprising an inorganic or organic substrate and a hot melt adhesive of the instant invention. Such adhesives can be applied by conventional means well known to those skilled in the art. In some embodiments, the substrate is glass, a plastic, a metal, a fabric or a film. One particularly preferred film is polyethyleneterephthalate—others include metal foils, polyolefins.

The invention also concerns methods of making an article. These methods comprise applying an adhesive of the present invention to a substrate's surface. Suitable substrates include those described above. In some preferred embodiments, the adhesive is used to bind two or more substrate surface layers together. The adhesively bound substrate surface layers may consist of the same substrate material or they may be different.

The adhesives of the instant invention can be applied to the substrate surface in layers that are 0.1 to 10 mils (2.5 μm-250 μm) in thickness. In some preferred embodiments, the thickness is 0.5 to 5 mils (12.5 μm-125 μm).

The invention is illustrated by the following examples which are intended to be illustrative but not limiting.

### EXAMPLES

Commercially available random copolyesters used in the comparative examples include those made by EMS Griltech. Two such compositions are EMS Griltex® D 1810 (4G//T/10, 100//50/50 bound mole ratio, DSC Mp=105 deg C., Tg=−38° C., MI=75 g/10 min@160° C. 2.16 kg, and Melt Viscosity=170 Pa*s@160 deg C.) and EMS Griltex D 1553 (4G/6G//T/6, 50/50//70/30 bound mole ratio (not confirmed by the distributor), DSC Mp=92° C., Tg=−13° C., MI=43 g/10 min@160° C., 2.16 kg, and Melt Viscosity=300 Pa*s@160 deg C. 4G is butanediol, 6G is hexanediol, T is terephthalic acid or its dimethyl ester, 10 is sebacic acid or its dimethyl ester, and 6 is adipic acid or its dimethyl ester.

Metallocene polyethylene/alpha-olefins used in the examples include Engage® 8402 and Vistamaxx® VM 1120 and PLTD 1859. Selected properties of the Vistamaxx® compositions are shown in the table below.

| Composition | CM | MI | D | Shore A/D | MP | Softening Point |
|---|---|---|---|---|---|---|
| VM 1120 | C3 | 9 | 0.861 | 59/NA | ˜120 | 44 |
| PLTD 1859 | C3 | 100 | 0.866 | N/A | <130 | |

In the above table, VM is Vistamaxx®, a metallocene catalyzed ethylene propylene copolymer from ExxonMobil. CM is co-monomer, C3 is propylene, MI is melt index (g/10 min, @190 deg C., 2.16 kg weight, ASTM D-1238), D is density in gm/cc, Shore A/Shore D (hardness measurement by needle penetration resistance, ASTM D-2240), MP is melting point deg C. (Fisher Johns Apparatus), and Softening Point—Vicat—(deg C., 200 g, ASTM D-1525)

Engage® 8402 used in the examples and other useful polyethylene/alpha-olefins are presented below. Engage® products are marketed by DuPont/Dow and Affinity® products are marketed by Dow Chemical Company. Exact® products are sold by ExxonMobil.

| | | | | | Flex | | | | |
|---|---|---|---|---|---|---|---|---|---|
| | | | | Shore | Modulus | | Vicat | Tensile | % |
| Product | CM % | MI | D | A/D | Mpa | MP | Soft | MPa | Elongation |
| Engage 8402 | 22 C8 | 30 | 0.902 | 94/44 | 69.9 | 98 | 76 | 12.9 | 790 |
| Engage 8400 | 40 C8 | 30 | 0.870 | 72/20 | 12.1 | 60 | 41 | 3.3 | 1,010 |
| Engage 8407 | 40 C8 | 30 | 0.870 | 72/20 | 12.1 | 60 | 41 | 3.3 | 1,010 |
| Engage 8411 | 33 C8 | 18 | 0.880 | 81/22 | 21.9 | 72 | 46 | 6.5 | 900 |
| Engage 8401 | 31 C8 | 30 | 0.885 | 85/32 | 25.8 | 78 | 46 | 6.4 | 950 |
| Affinity SM 1300 | C8 | 30 | 0.902 | | 71 | 98 | 79 | 10 | 624 |
| Affinity EG 8185 | C8 | 30 | 0.885 | | | 83 | | | |
| Exact 8210 | C8 | 10 | 0.882 | 79/27 | 26.2 | 74 | 71 | 3.3/300% | no break |
| Exact 3040 | C6 | 16.5 | 0.900 | | 72 | 96 | | 48 | 540 |
| Exact 0230 | C8 | 30 | 0.902 | 88/39 | 79.5 | 95.4 | 91.9 | 11.3 | 1,679 |
| Exact 3017 | C4 | 27 | 0.901 | NA/36 | 74 | 92 | 67 | 9 | 730 |

where:
CM % is % comonomer in polyethylene-co-alpha olefin;
MI is Melt Index g/10 min@190 deg C., 2.16 kg weight as described in ASTM D-1238;
D is Density (g/cc);
Shore A & Shore D Hardness is measured as described in ASTM D-2240;
Flexural Modulus is determined at 1% or 2% secant in Mpa as described in ASTM D-790;
Mp is Melt Point as determined by differential scanning calorimetry (DSC) at 10 deg/min;
Softening Point—Vicat is in ° C. as described in ASTM D-1525; and
Tensile Strength—Ultimate/break is in MPa and the method is described in ASTM D-638 and measured at 20 in/min.

Other compositions used in the examples include Bakelite® EPR 695 (an epoxy resin, viscosity=185 (mP*s units)@25° C., 50% w/w in dioxane, softening range 95° C.), sold by Hexion Specialty Chemicals. A compatibilizer, Lotader® AX8840 (a reactive polyethylene/GMA resin sold by Arkema) was used in certain comparative examples. A light stabilizer (Cyasorb® UV 5411, 2-(2′-hydroxy-5′-octylphenyl)-benzotriazole from Cytec Industries) and an antioxidant (Cyanox® XS4, a blend of Cyanox® 1790 phenolic antioxidant and Doverphos 9228 hydrolytically stable phosphite antioxidant) were used in some compositions.

Hytrel® 4056 (Mp=150° C., Tg=−50° C., a thermoplastic polyesterether elastomer marketed by DuPont), is a low modulus Hytrel® grade with nominal durometer hardness of 40 D, was used in some compositions. This composition contains a non-discoloring stabilizer.

In addition, the segmented copolyesterether compositions, the bound components of which are shown in the table below, were used in some compositions. These polymers were produced by the standard two stage process, the esterification and/or transesterification first stage followed by final vacuum polyesterification stage. TPA is terephthalic acid. IPA is isophthalic acid. BD is butanediol. PTMG (poly(tetramethyleneglycol)) is sometimes referred to as PTMEG, poly(tetramethyleneether) glycol, poly(butylene glycol), poly(tetramethyleneoxide) glycol, or poly(tetrahydrofuran). CHDA is 1,4-cyclohexanedicarboxylic acid. DMCD is dimethy-1,4-cyclohexanedicarboxylate.

| | D 1904E* | D 1905E* | D 1910E* | D 1843E* |
|---|---|---|---|---|
| Mol-% BD-TPA (a) | 53 | 59 | 59 | 59 |
| Mol-% BD-IPA (a) | 47 | 41 | 41 | 41 |
| Mol-% BD-BD (b) | 91 | 91 | 86 | 80 |
| Wt % copolyester | 70% | 70% | 60% | 50% |
| segment (d) | | | | |
| Mol-% PTMG 1000 (b) | 9 | 9 | 14 | 20 |
| Wt % PTMG 1000 (c) | 30% | 30% | 40% | 50% |
| DSC MP (° C.) | 116 | 128 | 119 | 105 |
| DSC Tg (° C.) | −25 | −25 | −35 | −40 |
| Melt Visc Pa*s @ | 389 | 316 | 450 | 226 |
| 160° C. | | | | |
| Melt Index @ | 31 | 42 | 27 | 53 |
| 160 deg | | | | |
| (g/10 min) | | | | |

*Supplied by EMS/Griltex ®-compositions and process dictated by Inventors
(a) These components are shown as mole percent of the total bound dibasic acid butanediol esters in the copolyester segment.
BD-TA = as terephthalate, BD-IPA = as Isophthalate, BD-CHDA = as cyclohexanedicarboxylate
(b) These components are shown as mole percent of total bound glycols.
(c) Wt % PTMG 1000 as PTMO in final segmented copolyesterether
(d) Wt % copolyester segment in final segmented copolyesterether

Additional compositions having the bound component ratios presented in the table below were made by the standard two stage esterification and/or transesterification/final vacuum polyesterification process.

| | GM 915* | GM913* | GM 920* |
|---|---|---|---|
| Mol-% BD-TA (a) | 65 | 65 | 50 |
| Mol-% BD-IPA (a) | 35 | 35 | |
| Mol-% BD-CHDA (a) | | | 50 |
| Wt % polyester segment (c) | 70% | 60% | 70% |
| Wt % PTMEG segment (b) | 30% | 40% | 30% |
| Melt Viscosity @ 200° C. Pa*s | 400 | 650 | 100 |
| DSC Mp ° C. | 139 | 126 | 107 |
| DSC Tg ° C. | −60 | −60 | −60 |

*Supplied by Toyobo/Vylon ® - compositions by analysis- unverified by supplier
(a) These components are shown as mole percent of the total bound dibasic acid butanediol esters in the copolyester segment.
BD-TA = as terephthalate, BD-IPA = as Isophthalate, BD-CHDA = as cyclohexanedicarboxylate
(b) Wt % PTMEG, Mn 1000-2000, in final segmented copolyesterether as PTMO
(c) Wt % copolyester segment in final segmented copolyesterether

For GM915, about 70 wt % (d) of the composition is the copolyester segment. The polyether segment is about 30 wt % (c) of the composition. The other compositions are designated in an analogous fashion.

Prototype blends were prepared by mechanical hand mixing of the melted components on a heated surface and applied to PET film followed by draw down of the melt under pressure between the top sheet and the base sheet to make the laminate. As the crystallization proceeded, peel strength was evaluated periodically over the first week aging and some times beyond.

Other hot melt blend formulations (250 g each) were made in a Haake kneader-mixing bowl. Larger quantities of the formulations were made in a Buss Kneader Extruder (46 mm), fitted with an under water die faced strand pelletizer followed by a fluidized bed pellet dryer.

### Comparative Examples A-F

The following compositions were utilized in the formulations:

| | A | B | C | D | E | F |
|---|---|---|---|---|---|---|
| EMS Griltex | 100 | | 83.34 | 90.90 | | |
| D 1810 | | | | | | |
| EMS Griltex | | 100 | | | 83.34 | 90.90 |
| D 1553 | | | | | | |
| Engage8402 | | | 16.66 | 9.10 | 16.66 | 9.10 |

Comparative Examples C, D, E, and F using EMS Griltex® non-segmented random copolyesters (devoid of polyalkyleneoxide segments) were unsuitable for use in adhesive applications due to macrophase separation and gross incompatibility of the copolyester/Engage 8402 blends, as well as gross loss of their mechanical/physical properties.

### Comparative Examples G-I

The following blend formulations were made using EMS Griltex non-segmented random copolyesters (devoid of polyalkyleneoxide segments), Engage® 8402 plus functionalized olefin compatibilizers.

Formulation: copolyesters/Engage 8402/compatibilizers + epoxy

| | Comparative Example | | |
|---|---|---|---|
| | G | H | I |
| Ingredient | WT % | WT % | WT % |
| EMS Griltex 1810 E | 78.741 | 78.741 | |
| (copolyester A) | | | |
| EMS Griltex 1553 E | | | 75.709 |
| (copolyester B) | | | |
| Bakelite EPR 695 | 7.874 | 11.811 | 11.358 |
| Lotader AX8840 | 3.937 | 2.628 | 3.790 |
| Engage 8402 | 7.874 | 5.246 | 7.569 |
| Cyasorb UV 5411 | 1.476 | 1.476 | 1.476 |
| Cyanox XS4 | 0.098 | 0.098 | 0.098 |
| Total | 100.000 | 100.000 | 100.000 |

Adhesive blends based on copolyesters (containing no polyalkyleneoxide segments) and polyethylene co alpha olefin plastomers were only marginal adhesives. These compositions could only be obtained at lower Engage® 8402 content along with high concentrations of polyfunctional functionalized polyethylene compatibilizers and the required addition of high concentrations of o-cresol novolac epoxy resins. Even then, only marginal compatibility was obtained, but the resultant hot melt adhesives gained viscosity or gelled in the extruder and lines during commercial application conditions. The PET film adhesion of these formulations was only marginally improved over the polyester itself.

7 Day peel test results are presented in the following table. (Laminates produced in a heated hydraulic press (PHI model# QL-430) 1 min@153 psi@160 deg C. 0.75 milPET/3-5 mil adhesive/0.75 milPET. Laminate Peel Values (Instron Mini 44)—180 deg peel, 1 inch strip, 2″/min.)

| | 7 Day Aged Peel | |
|---|---|---|
| Composition | lbs/in (PLI) | Application Viscosity |
| Copolyester A | <2.0 | OK |
| G | <4.5 | Viscosity increased/gel |
| | | formation |
| H | <5.5 | Viscosity increased/gel |
| | | formation |
| Copolyester B | <1.5 | OK |
| I | <3.0 | Viscosity increased/gel |
| | | formation |

### Comparative Examples J-Q

The following compositions were melt blended made using D 1843A, a segmented copolyesterether.

| Ingredient | Ex. J | Ex. K | Ex. L | Ex. M | Ex. N | Ex. O | Ex. P | Ex. Q |
|---|---|---|---|---|---|---|---|---|
| D1843A | 87.820 | 82.056 | 84.320 | 84.320 | 82.007 | 81.960 | 81.960 | 81.960 |
| Lotader | 3.510 | 3.280 | 3.510 | 2.810 | 2.733 | 3.280 | 2.460 | 5.450 |
| AX8840 | | | | | | | | |
| Engage 8402 | 7.030 | 13.132 | 10.530 | 11.230 | 13.665 | 13.120 | 13.940 | 10.950 |
| Cyasorb UV | 1.540 | 1.439 | 1.540 | 1.540 | 1.498 | 1.540 | 1.540 | 1.540 |
| 5411 | | | | | | | | |
| Cyanox XS4 | 0.100 | 0.093 | 0.100 | 0.100 | .097 | 0.100 | 0.100 | 0.100 |
| Total | 100 | 100 | 100 | 100 | 100 | 100 | 100 | 100 |

Viscosity measurements taken at 190 to 200° C. over time, 24 hours, for all formulations (including the lowest concentration of “compatibilizer” Lotader® AX8840 in the blend) showed viscosity increases. These viscosity increases could result in production line as well as application problems. No reduction in Engage® compatibility in the adhesive was seen as the amount of compatibilizer concentration was reduced. It is noted, that when formulating copolyesters (without polyether segments) alone with metallocene polyethylene co alpha olefin plastomers without added sufficient functional compatibilizers, gross macrophase separation resulted accompanied by poor adhesive qualities and mechanical strength.

### Examples 1-7

The following formulations were blended using a Haake mixing bowl (135-155 deg C. mix temp.). 913, 915 and 920 are GM913, GM915, and GM920 respectively. The compositions of these segmented copolyesterethers by analysis is disclosed herein. 8402 is Engage® 8402 polyethylene-alpha-olefin described herein. 1843 is D 1843E is a segmented polyesterether whose composition is described herein.

The weight ratio nomenclature is as follows. A designation 25/25/50//20 indicates that the components represented by the first three numbers (before the //) are individual segmented polyesterether components present at 25%, 25% and 50% by weight respectively relative to the total segmented polyesterether component. The number after the //, in this case 20, indicates that 20 parts polyethylene-alpha-olefin per hundred parts segmented polyesterether components.

| Example | Composition | Weight Ratios |
|---|---|---|
| 1 | 915/920//8402 | 25/75//20 |
| 2 | 913/920//8402 | 25/75//20 |
| 3 | 913/920//Vistamaxx 1120 | 30/70//20 |
| 4 | 913/920/1843//8402 | 25/25/50//20 |
| 5 | 915/920/1843//8402 | 25/25/50//20 |
| 6 | 4056/1843//8402 | 23/77//23 |
| 7 | 4056/1843//8402 | 20/80//25 |

Scale-up of these formulations (above) were made in a 46 mm Buss Kneader Extruder at 135-150 deg C. batch temperature as shown below. The numbers in the table are presented as weight percentages relative to the total composition.

Scale-up of these formulations (above) were made in a 46 mm Buss Kneader Extruder at 135-150 deg C. batch temperature as shown below. The numbers in the table are presented as weight percentages relative to the total composition.

| | Example | | | | | | |
|---|---|---|---|---|---|---|---|
| component | 1 | 2 | 3 | 4 | 5 | 6 | 7 |
| GM 920 | 61.511 | 61.511 | 58.334 | 20.501 | 20.501 | | |
| EMS | | | | 41.010 | 41.010 | 61.620 | 62.99 |
| Griltex 1843 | | | | | | | |
| GM 915 | 20.505 | | | | 20.505 | | |
| GM 913 | | 20.505 | 25.000 | 20.505 | | | |
| Hytrel 4056 | | | | | | 18.400 | 15.745 |
| Vistamaxx 1120 | | | 16.666 | | | | |
| Engage 8402 | 16.404 | 16.404 | | 16.404 | 16.404 | 18.400 | 19.685 |
| Cyasorb | 1.480 | 1.480 | | 1.480 | 1.480 | 1.480 | 1.480 |
| UV 5411 | | | | | | | |
| Cyanox XS4 | 0.100 | 0.100 | | 0.100 | 0.100 | 0.100 | 0.100 |
| Total | 100 | 100 | 100 | 100 | 100 | 100 | 100 |

### Examples 8-13

The compositions of examples 1-5 and 7 were applied between two 0.75 mil PET films heat pressed to a 3-5 mil adhesive thickness to form the test laminates. Laminates were produced in a heated PHI model# QL-430 hydraulic press 1 min dwell@155 psi@160 deg C., 0.75 milPET/3-5 mil adhesive/0.75 milPET technique. Peel values (pli, lbs/in width) were measured using Laminate Peel Values—Instron Mini 44,180 deg peel, 1 inch strip, 2″/min technique. Results are presented in the table below with all numbers reported in pli units. Results were obtained at the temperatures listed. Watersoak laminate peel values were determined (after 24 Hrs water immersion). Control peel values were obtained at room temperature (77 deg F.).

Peel test results 24 hours after lamination are reported in the table below.

| | | Unblended | Room | | | 24 hr |
|---|---|---|---|---|---|---|
| | | copolyester- | Temper- | | | Water- |
| | Comp.. | ether Control | ature | | | soak |
| | (Example | (no 8402) | 77° F. | 125° F. | 150° F. | 77° F. |
| Ex. | Number) | 77° F. Peel | Peel | Peel | Peel | Peel |
| 8 | 1 | <7.5 | 12.18 | 6.33 | 3.26 | 15.14 |
| 9 | 5 | <7.5 | 13.61 | 3.77 | 0.74 | 15.20 |
| 10 | 2 | <7.5 | 13.78 | 6.98 | 5.41 | 17.80 |
| 11 | 4 | <7.5 | 14.74 | 5.30 | 1.84 | 6.92 |
| 12 | 7 | <7.5 | 10.68 | 3.86 | 1.10 | 12.51 |
| 13 | 3 | <8.0 | >14.00 | >7.00 | >5.00 | >18.00 |

### Examples 14-19

Peel results are presented below after structures were aged 7 days after lamination Other details are the same as in Examples 8-13.

| | | Unblended Segmented | | | | |
|---|---|---|---|---|---|---|
| | | Polyesterether | Room Temp | | | Watersoak |
| | Composition | Control (no 8402) | (77° F.) | 125° F. | 150° F. | 77° F. |
| Example | (Example Number) | 77° F. Peel | Peel | Peel | Peel | Peel |
| 14 | 1 | <2.5 | 20.36 | 8.03 | 4.16 | 11.09 |
| 15 | 5 | <2.5 | 5.80 | 4.12 | 0.91 | 17.00 |
| 16 | 2 | <2.5 | 20.82 | 9.37 | 6.79 | 18.52 |
| 17 | 4 | <2.5 | 8.08 | 8.24 | 4.09 | 23.25 |
| 18 | 7 | <2.5 | 17.8 | 8.56 | 1.30 | 15.43 |
| 19 | 3 | <2.0 | >20.00 | >10.00 | >7.00 | >18.00 |

### Examples 20 and 21, Comparative Examples R and S

Peel values using PET/adhesive/PET laminates consisting of 0.75 mil PET film thickness with a 25 g/sq meter adhesive coat weight were performed after 0, 6, 18, weeks exposure in a humidity chamber at 50° C. at 95% relative humidity (RH). The peel test (pli—pounds/linear inch) was run as described above except as noted.

| | Composition | | | | | | |
|---|---|---|---|---|---|---|---|
| | (Example | Before | | After 6 Weeks | | After 18 Weeks | |
| Example | Number) | Exposure | | of Exposure | | of Exposure | |
| 20 | 2 | >12 | pli | >12 | pli | 6-8 | pli |
| 21 | 4 | 11-12 | pli | 10.2 | pli | 6-8 | pli |
| Compara- | — | >4 | pli | 2.4 | pli | 0.2-0.3 | pli |
| tive R | | | | | | | |
| Compara- | — | >4 | pli | 1.12 | pli | 0.2-0.3 | pli |
| tive S | | | | | | | |

R = Bostik 1910
S = Bostik 1912

These are commercial random flexible semicrystalline copolyesters reported and marketed by supplier to have improved retained laminate adhesion and improved laminate adhesion after prolonged exposure to high humidity

All patents and articles disclosed herein are incorporated herein in their entirety.

What is claimed:

1. A composition comprising:
(a) about 100 parts by weight of a segmented copolyesterether derived from:
one or more of C₂-C₁₂ aliphatic and C₅-C₁₂ cycloaliphatic glycol(s);
α,ω-hydroxy terminated polyalkyleneoxide(s) having a number average molecular weight of from about 250 to about 6000; and
one or more of C₈-C₃₆ aromatic dibasic acids, cycloaliphatic dibasic acids, C₆-C₁₂ linear aliphatic dibasic acids, and C₁-C₄ dialkylesters thereof; and
(b) about 3 to about 45 parts by weight of one or more metallocene catalyzed polyethylene co (C₃-C₁₂)alpha-olefin plastomers having a density of from about 0.85 to about 0.91 g/cm³, said plastomer being essentially free of reactive functional groups; and
the composition being essentially free of additional external reactive functionalized polyolefin compatibilizers.

2. The composition of claim 1 wherein the α,ω-hydroxy terminated polyalkyleneoxide(s) has a number average molecular weight of from about 650 to about 6000.

3. The composition of claim 1 wherein component a) comprises:
one or more of C₂-C₁₂ aliphatic and C₅-C₁₂ cycloaliphatic glycol(s);
α,ω-hydroxy terminated polyalkyleneoxide(s) having a number average molecular weight of from about 650 to about 6000; and
one or more of C₈-C₃₆ aromatic dibasic acids, cycloaliphatic dibasic acids, and C₁-C₄ dialkylesters thereof.

4. The composition of claim 1 wherein the one or more of C₂-C₁₂ aliphatic and C₅-C₁₂ cycloaliphatic glycol(s) comprises at least one of 1,4-butanediol, 1,6-hexanediol and 1,4-cyclohexanedimethanol.

5. The composition of claim 1 wherein the one or more of C₂-C₁₂ aliphatic and C₅-C₁₂ cycloaliphatic glycol(s) comprises 1,4-butanediol.

6. The composition of claim 1 wherein the one or more of C₁-C₁₂ aliphatic and C₅-C₁₂ cycloaliphatic glycol(s) comprises cyclohexanedimethanol.

7. The composition of claim 1 wherein the α,ω-hydroxy terminated polyalkyleneoxide is a compound where the alkylene segment is from C₂ to C₈.

8. The composition of claim 1 wherein the α,ω-hydroxy terminated polyalkyleneoxide is a polytetramethyleneoxide glycol.

9. The composition of claim 8 wherein the polytetramethyleneoxide glycol has a molecular weight (Mn) of from about 650 to about 2000.

10. The composition of claim 1 wherein the one or more of C₈-C₃₆ aromatic and cycloaliphatic dibasic acid or their C₁-C₄ dialkylester(s) comprises at least one of 1,4-cyclohexanedicarboxylic acid (CHDA) and terephthalic acid.

11. The composition of claim 1 wherein the one or more of C₈-C₃₆ aromatic and cycloaliphatic dibasic acid(s) is at least one of terephthalic acid and isophthalic acid.

12. The composition of claim 1 wherein:
one or more of C₂-C₁₂ aliphatic and C₅-C₁₂ cycloaliphatic glycol(s) comprises at least one of butanediol, 1,6-hexanediol and cyclohexanedimethanol,
α,ω-hydroxy terminated polyalkyleneoxide is a polytetramethylene glycol; and
one or more of C₈-C₃₆ aromatic dibasic acids, cycloaliphatic dibasic acids, C₆-C₁₂ linear aliphatic dibasic acids and C₁-C₄ dialkylesters thereof comprises at least one of 1,4-cyclohexanedicarboxylic acid, terephthalic acid and isophthalic acid.

13. An article comprising a substrate and a composition of claim 1.

14. The article of claim 13 wherein the substrate is a fabric or film.

15. The article of claim 14 wherein the film is polyethyleneterephthalate.

16. An article comprising a substrate and a composition of claim 3.

17. The article of claim 13 wherein the substrate is a fabric or film.

18. The article of claim 14 wherein the film is polyethyleneterephthalate.

19. A method of making an article comprising applying the composition of claim 1 to a substrate.

20. The method of claim 19 wherein the substrate comprises a fabric or film.

21. The method of claim 19 wherein the composition of claim 1, optionally comprising a carrier, is applied to the substrate as a dispersion or paste, and then the composition and substrate are heated to a temperature sufficient volatize the carrier when present, and to melt and fuse the composition.

22. The method of claim 21 further comprising contacting said composition, which has been applied to the substrate, to a second substrate, the second substrate being the same or different than the substrate.

23. The method of claim 19 wherein the composition of claim 1 is applied to the substrate in powder or web form and then melt fused to the substrate.
